(19) United States
(12) Patent Application Publication
(10) Pub. No.: US 2005/0063118 A1
(43) Pub. Date: Mar. 24, 2005

(54) Multipole overvoltage protection system and method for the reliable operation of a multipole overvoltage protection system

(75) Inventors: Rainer Durth, Meinberg (DE); Martin Wetter, Detmold (DE); Klaus Scheibe, Kiel (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Phoenix Contact GmbH & Co. KG, Blombert (DE)

(21) Appl. No.: 10/500,353

(22) PCT Filed: Dec. 5, 2002
(86) PCT No.: PCT/EP02/13768

(30) Foreign Application Priority Data
Dec. 31, 2001 (DE) 101 64 232.6

(51) Int. Cl. H02H 3/20

(52) U.S. Cl. 361/91.1

(57) ABSTRACT

A multipole overvoltage protection system for a multiphase power supply system includes a first overvoltage protection element connected in a first leg of the power supply system and a second overvoltage protection element connected in a second leg of the power supply system. The second overvoltage protection element is coupled to the first overvoltage protection element so that the second overvoltage protection element ignites when the first overvoltage protection element ignites and the first overvoltage protection element ignites when the second overvoltage protection element ignites.

The present invention relates to a multipole overvoltage protection system for a multiphase power supply system, in particular, a low voltage system, including at least two overvoltage protection elements; each leg of the power supply system having one overvoltage protection element arranged therein. In addition, the present invention relates to a method for the reliable operation of such a multipole overvoltage protection system.

Electrical, but especially electronic measurement, control and switching circuits, mainly also telecommunications equipment and systems, are sensitive to transient overvoltages, as can occur especially as a result of atmospheric discharges, but also due to short circuits and switching operations in power supply systems. This sensitivity has increased in the same measure that electronic components, especially transistors and thyristors, have been used; in particular, the integrated circuits which have been increasingly used are greatly endangered by transient overvoltages.

Electrical circuits normally operate without problems at the voltage specified for them, i.e., the rated voltage. This is not true when overvoltages occur. Overvoltages are considered to be all voltages which are above the upper tolerance limit of the rated voltage. They include mainly transient overvoltages which can occur not only from atmospheric discharges, but also from switching operations or short circuits in power supply systems. Such overvoltages can be conductively, inductively or galvanically coupled into electrical circuits. In order to protect electrical or electronic circuits, especially electronic measurement, control and switching circuits, and, in particular, telecommunications equipment and systems—no matter where they are used—against transient overvoltages, overvoltage protection elements have been developed and in use for more than twenty years.

An important component of overvoltage protection elements of the type in question, which are often also referred to as “lightning current arresters”, is at least one spark gap which arcs over at a certain overvoltage, i.e., the sparkover voltage, and thus prevents overvoltages which are larger than the sparkover voltage of the spark gap from occurring in the circuit protected by the overvoltage protection element.

The spark gaps of the overvoltage protection elements mentioned at the outset are usually designed as air breakdown spark gaps, i.e., they have two electrodes with an air breakdown spark gap being present or acting therebetween. “Air breakdown spark gap” is understood to mean a breakdown spark gap in general, and is therefore intended to include also a breakdown spark gap where a gas other than air is present between the electrodes. Besides overvoltage protection elements having an air breakdown spark gap, there are overvoltage protection elements which have an air flashover spark gap and in which a creeping discharge occurs when the spark gap arcs over.

In comparison with overvoltage protection elements having an air flashover spark gap, the overvoltage protection elements having an air breakdown spark gap have the advantage of a greater surge current carrying capacity, but the disadvantage of a higher and not particularly constant sparkover voltage. Therefore, various overvoltage protection elements having an air breakdown spark gap have been proposed in the past which have been improved with respect to the sparkover voltage.

Here, in the area of the electrodes or the air breakdown spark gap acting between the electrodes, ignition aids have been implemented in various ways, for example, by providing at least one ignition aid between the electrodes which triggers a creeping discharge and which projects at least partially into the air breakdown spark gap; the ignition aid being made in the form of a crosspiece of plastic (cf., e.g., Unexamined German Laid-Open Patent Applications 41 41 681 or 44 02 615).

The ignition aids which were addressed above and which are provided in the known overvoltage protection elements may be called, as it were, “passive ignition aids” because they do not themselves arc over “actively”, but only in response to an overvoltage occurring at the main electrodes.

Unexamined German Laid-Open Patent Application 198 03 636 also describes an overvoltage protection element having two electrodes, an air breakdown spark gap acting between the two electrodes, as well as an ignition aid. Unlike the ignition aids described above, which trigger a creeping discharge, the ignition aid of this known overvoltage protection element is designed as an “active ignition aid” in that, in addition to the two electrodes referred to as “main electrodes” there, two ignition electrodes are provided as well. These two ignition electrodes form a second air breakdown spark gap which serves as an ignition spark gap. In this known overvoltage protection element, the ignition aid includes an ignition circuit with an ignition switching element in addition to the ignition spark gap. When an overvoltage is present at the known overvoltage protection element, the ignition circuit with the ignition switching element causes the ignition spark gap to arc over. The ignition spark gap, i.e., the two ignition electrodes, are arranged with respect to the two main electrodes in such a manner that arcing-over of the ignition spark gap causes arc-over of the air breakdown spark gap between the two main electrodes, which is referred to as “main spark gap”. Arcing over of the ignition spark gap leads to ionization of the air present in the air breakdown spark gap so that after the ignition spark gap has arced over, the air breakdown spark gap between the main electrodes, i.e., the main spark gap, suddenly arcs over as well.

In the known, above-described types of overvoltage protection elements having ignition aids, the ignition aids lead to an improved, i.e., lower and more constant sparkover voltage.

For overvoltage protection of the central power supply in low voltage systems, it is known to use three- or four-pole overvoltage protection devices, in which the individual overvoltage protection elements are interconnected into an overvoltage protection system and located in a common housing. In this context, the individual overvoltage protection elements each protect only one leg of the power supply system. Depending on the wiring of the overvoltage protection device, the specified protection level is only guaranteed between the active phase conductors (L1, L2, L3) and the neutral conductor (N) and between the neutral conductor (N) and ground (PE), or between the active phase conductors (L1, L2, L3) and ground (PE) and between the neutral conductor (N) and ground (PE). In particular between the individual active phase conductors (L1, L2, L3), however, the protection level is not guaranteed.

But then it may happen that, due to inductive or capacitive coupling (crosstalk) during the occurrence of an overvoltage in only one leg, an (albeit smaller) overvoltage occurs in another leg, which, however, does not trip the overvoltage protection element of this leg. Moreover, even in the case of actually identically rated overvoltage protection elements and identically rated legs, the total surge current may be unevenly distributed during an overvoltage event, especially if the individual overvoltage protection elements operate in a time-staggered manner, or if individual overvoltage protection elements do not operate at all. In practice, multipole overvoltage protection devices are offered which have a discharge capacity up to a certain total surge current level, but in which the individual overvoltage protection elements can only discharge a corresponding portion of the specified total surge current (one third in the case of three legs, or one fourth in the case of four legs, respectively). If now an unsymmetrical current distribution occurs in these overvoltage protection devices, then this can result in overloading of individual overvoltage protection elements.

It is therefore an object of the present invention to provide a multipole overvoltage protection system which ensures the desired protection level between all legs, and which is nevertheless easy and therefore inexpensive to manufacture. It is yet another object of the present invention to provide a method for the reliable operation of a multipole overvoltage protection system, ensuring that a desired protection level is reached between all legs of a multiphase power supply system.

The multipole overvoltage protection system according to the present invention, in which the above-described objective is achieved, is first of all and essentially characterized in that the individual overvoltage protection elements are coupled to each other in such a manner that when one overvoltage protection element is ignited, all other overvoltage protection elements are ignited as well.

If an overvoltage greater than the in the sparkover voltage occurs in one leg at the overvoltage protection system according to the present invention, then this leads to the igniting of the overvoltage protection element located in this leg. Because, according to the present invention, the individual overvoltage protection elements are coupled to each other, the overvoltage protection elements in the other legs are then automatically ignited as well. This guarantees the desired protection level between all legs, and ensures symmetrical distribution of the total surge current.

The individual overvoltage protection elements can be coupled to each other by different means. In a first preferred embodiment of the overvoltage protection system according to the present invention, the individual overvoltage protection elements each have one ignition aid; the individual ignition aids being coupled to each other.

In this context, both the “passive ignition aids” described at the outset and the above-described “active ignition aids” can be used as the ignition aids. When using “active ignition aids” which, in addition to an ignition electrode, also include an ignition circuit with an ignition switching element, then the separate ignition switching elements of the individual ignition aids are electrically connected to each other.

According to an alternative embodiment of the multipole overvoltage protection system according to the present invention, a central ignition aid is provided to which all overvoltage protection elements are electrically connected. This embodiment has the advantage that fewer components are required altogether so that the overvoltage protection system can, on the one hand, be produced more cost-effectively and, on the other hand, with smaller dimensions. If, in turn, the central ignition aid is designed as an “active ignition aid”, then it preferably has a plurality of ignition electrodes and a central ignition circuit which is connected to the ignition electrodes; each ignition electrode cooperating with one overvoltage protection element, respectively.

In a particularly preferred practical embodiment of the multipole overvoltage protection system according to the present invention, all overvoltage protection elements and, if applicable, all ignition aids are located in a common housing, thus integrating the multipole overvoltage protection system as a multipole overvoltage protection device. In this context, the individual overvoltage protection elements preferably have a first electrode, a second electrode, and an air breakdown spark gap present or acting between the electrodes; the electrodes of the individual overvoltage protection elements being arranged with respect to each other such that when the air breakdown spark gap of one overvoltage protection element is ignited, the air breakdown spark gaps of other overvoltage protection elements are ignited as well because of the plasma which is then present.

When it is said above that the individual overvoltage protection elements have a first electrode and a second electrode, it is only meant in a functional way; in fact, it is not necessary that a first electrode and a second electrode exist for each overvoltage protection element; rather, it is possible to provide one electrode that acts as the second electrode for several or all of the overvoltage protection elements.

In the initially described method for the reliable operation of a multipole overvoltage protection system in a multiphase power supply system, in particular, in a low voltage system, where the overvoltage protection system has at least two overvoltage protection elements which are each arranged in a leg of the power supply system, the aforementioned objective is achieved according to the present invention in that when a single overvoltage protection element is ignited, all other overvoltage protection elements are ignited as well.

According to a first embodiment of the method, in which the individual overvoltage protection elements each have one ignition aid, igniting of an ignition aid of one overvoltage protection element will cause all other ignition aids of the remaining overvoltage protection elements to be ignited as well. According to an alternative embodiment of the method, in which the individual overvoltage protection elements are designed as air breakdown spark gaps and located in a common housing, the plasma produced upon igniting of an air breakdown spark gap of one overvoltage protection element will automatically ignite the breakdown spark gaps of the remaining overvoltage protection elements.

Specifically, the multipole overvoltage protection system and the method for the reliable operation of a multipole overvoltage protection system according to the present invention can be embodied and refined in many ways. In this regard, on the one hand, reference is made to the patent claims that are subordinate to Patent claims 1 and 12 and, on the other hand, to the following description of preferred exemplary embodiments in conjunction with the drawing, in which

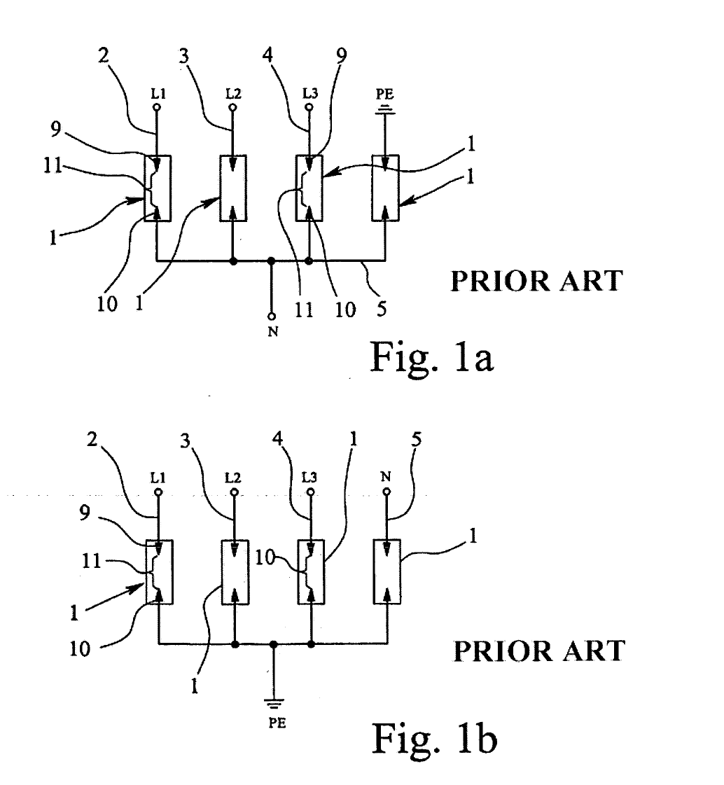

FIG. 1 shows two simplified circuit diagrams of a multipole overvoltage protection system known in the prior art for two different network configurations;

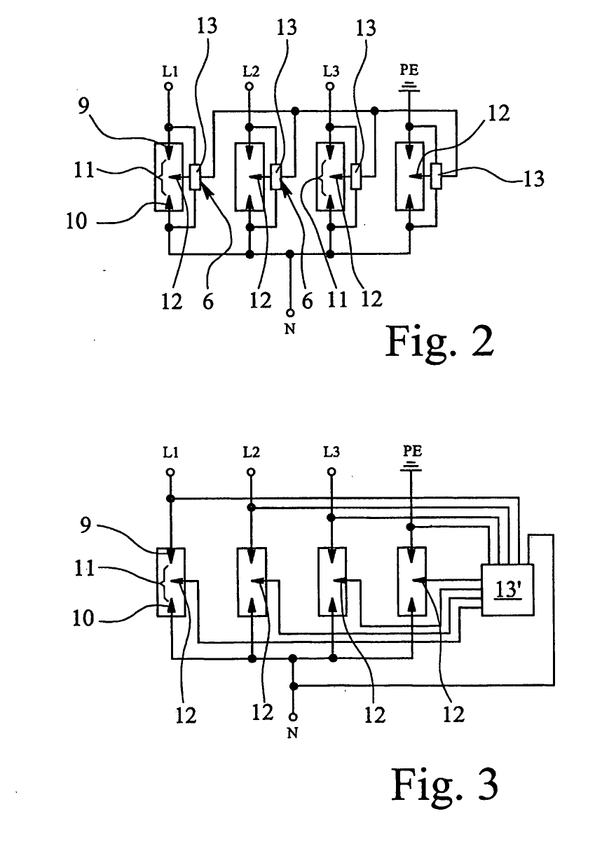

FIG. 2 shows a simplified circuit diagram of a first exemplary embodiment of a multipole overvoltage protection system according to the present invention;

FIG. 3 shows a simplified circuit diagram of a second exemplary embodiment of a multipole overvoltage protection system according to the present invention;

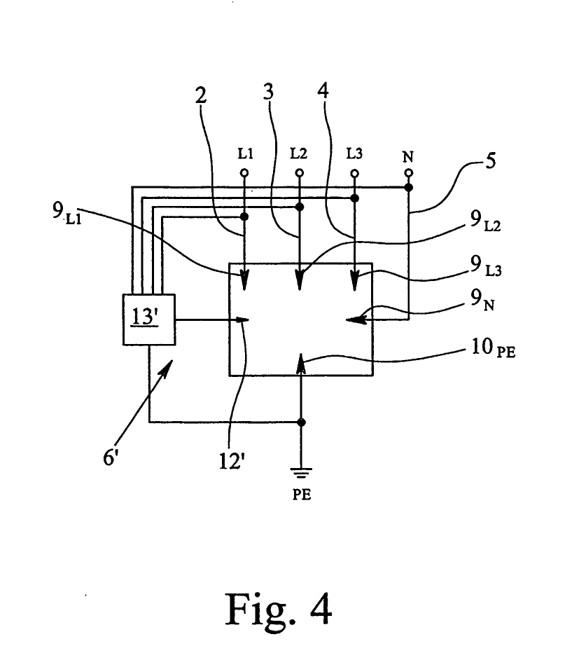

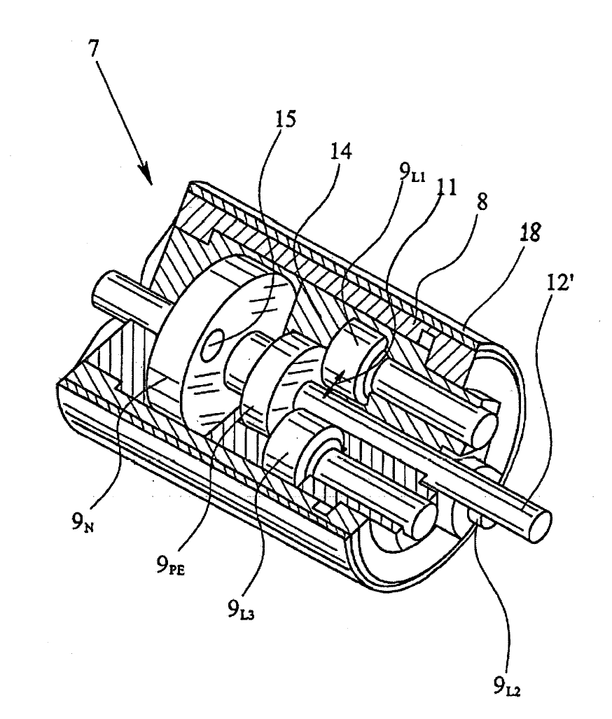

FIG. 4 shows a simplified circuit diagram of a third exemplary embodiment of a multipole overvoltage protection system according to the present invention; and

FIG. 5 is a partially sectional view of an exemplary embodiment of a multipole overvoltage protection device of the present invention according to the circuit diagram of FIG. 4.

FIGS. 1a and 1b each show a simplified circuit diagram of a multipole overvoltage protection system known in the prior art for a three-phase power supply system, including a total of four overvoltage protection elements 1. The circuit diagram according to FIG. 1a shows a “3+1 circuit” whereas FIG. 1b symbolizes a “4+0 circuit”.

In FIGS. 1 through 4, the active phase conductors of a low voltage system are denoted by L1, L2 and L3 while N refers to the associated neutral conductor. Each leg 2, 3, 4 and 5 of the low voltage system has an overvoltage protection element 1 arranged therein.

In the “3+1 circuit” according to FIG. 1a, the respective overvoltage protection elements 1 guarantee a corresponding protection level both between the individual active phase conductors L1, L2, L3 and the neutral conductor N, and between the neutral conductor N and the ground connection PE. In the “4+0 circuit” according to FIG. 1b, the individual overvoltage protection elements 1 guarantee the protection level, on the one hand, between the individual active phase conductors L1, L2, L3 and the ground connection PE and, on the other hand, between the neutral conductor N and the ground connection PE.

From FIG. 2, it can be seen, first of all, that the individual overvoltage protection elements 1 of the overvoltage protection system according to the present invention each have one ignition aid 6, which is known per se in the prior art. However, according to the present invention, the individual ignition aids 6 are coupled to each other in such a manner, namely electrically, that when one ignition aid 6 is ignited due to the occurrence of an overvoltage in the respective leg 2, 3, 4 or 5, the other ignition aids 6 are automatically ignited as well. Thus, the interconnection of the individual ignition aids 6 ensures that when an overvoltage occurs at the multipole overvoltage protection system as a whole, all overvoltage protection elements 1 will be ignited, thus preventing the occurrence of damaging overvoltages between the individual legs 2, 3, 4, 5.

In the multipole overvoltage protection system shown in the Figures, and in the overvoltage protection device 7 depicted in FIG. 5, where the individual overvoltage protection elements 1 are located in a common housing 8, the individual overvoltage protection elements 1 each have a first electrode 9, a second electrode 10, and an air breakdown spark gap 11 present or acting between the two electrodes 9, 10. Besides the overvoltage protection elements 1 shown here, which have an air breakdown spark gap 11, it is, in principle, also possible to use overvoltage protection elements which have an air flashover spark gap, and in which a creeping discharge occurs when they arc over. Due to the greater surge current carrying capacity, it is preferred to use overvoltage protection elements 1 having an air breakdown spark gap 11 for the overvoltage protection systems in question, which are also referred to as “lightning current arresters”.

From FIG. 2 it can also be seen that the individual ignition aids 6 each have an ignition electrode 12 and an ignition circuit 13 which is connected to ignition electrode 12. In this context, the individual ignition aids 6 are coupled to each other through electrical interconnection of the individual ignition circuits 13.

In contrast to the embodiment according to FIG. 2, in which each ignition aid 6 has both an ignition electrode 12 and an ignition circuit 13, the exemplary embodiment according to FIG. 3 only has one central ignition circuit 13′. In this context, this central ignition circuit 13′ is connected both to the individual legs 2, 3, 4, 5 and to the individual ignition electrodes 12. Thus, when one overvoltage protection element 1 is ignited, the common ignition circuit 13′ causes the other overvoltage protection elements 1 to be ignited at the same time as well.

FIG. 4 shows the circuit diagram of a multipole overvoltage protection system which has been further improved, and in which not only the individual ignition circuits 13 have been replaced by a central ignition circuit 13′, but in which, moreover, just one central ignition electrode 12′ is provided instead of individual ignition electrodes 12 so that the multipole overvoltage protection system has only one central ignition aid 6′ in total.

From FIG. 4, it can also be seen that the individual overvoltage protection elements 1 do each have a first electrode 9_{L1}, 9_{L2}, 9_{L3} and 9_{N}, but that they do not each have a separate second electrode, and that only one “common” second electrode 10_{PE} is provided instead. Thus, for example, the air breakdown spark gap 11 of the overvoltage protection element 1 of leg 2, i.e., of the active phase conductor L₁, is formed by electrode 9_{L1} as the first electrode and electrode 10_{PE} as the second electrode.

FIG. 5 shows a practical embodiment of a multipole overvoltage protection system, in which the individual electrodes 9_{L1}, 9_{L2}, 9_{L3}, 9_{N} and 10_{PE} and the common ignition electrode 12′ are located in a housing 8, altogether forming a multipole overvoltage protection device 7. In this context, the individual electrodes 9_{L1}, 9_{L2}, 9_{L3}, 9_{N} and 10_{PE} and the common ignition electrode 12′ are arranged coaxially with respect to each other, and each have a circular cross-section. Alternatively, the individual electrodes 9_{L1}, 9_{L2}, 9_{L3}, 9_{N} and 10_{PE} and the common ignition electrode 12′ can also have an oval or rectangular cross-section. In this context, it is particularly advantageous if the individual electrodes 9_{L1}, 9_{L2}, 9_{L3}, 9_{N} and 10_{PE} and the common ignition electrode 12′ have different cross-sections over their length so that the individual electrodes 9_{L1}, 9_{L2}, 9_{L3}, 9_{N} and 10_{PE} and the common ignition electrode 12′ are stepped in cross-section over their length, which allows the location of the region that is intended to act as air breakdown spark gap 11 to be predetermined in a special way.

The interior space of housing 8, which preferably has a pressure-tight and pressure-resistant design, has a lining 14 which is composed, in particular, of POM-Teflon In order to further improve the pressure tightness of housing 8, the housing can be enclosed by an outer pressure cylinder (not shown here). Finally, it is also shown in FIG. 5 that a hole 15 is formed in the electrode ⁹N of the neutral conductor N. This hole 15 permits pressure equalization within housing 8 in that it allows plasma to escape from the region of air breakdown spark gaps 11 (in FIG. 5 the region to the right of electrode ⁹N) to a region (in FIG. 5 the region to the left of electrode ⁹N) where the electrodes 9_{L1}, 9_{L2}, 9_{L3}, 9_{N} and 10_{PE} are spaced further apart because of their stepped cross-section over their length.

1-14. (canceled)

15. A multipole overvoltage protection system for a multiphase power supply system, the multipole overvoltage protection system comprising:
a first overvoltage protection element connected in a first leg of the power supply system; and
a second overvoltage protection element connected in a second leg of the power supply system, the second overvoltage protection element being coupled to the first overvoltage protection element so that the second overvoltage protection element ignites when the first overvoltage protection element ignites and the first overvoltage protection element ignites when the second overvoltage protection element ignites.

16. The overvoltage protection system as recited in claim 15 further comprising a first ignition aid associated with the first overvoltage protection element and a second ignition aid associated with the second overvoltage protection element, the first and second ignition aids being coupled to each other.

17. The overvoltage protection system as recited in claim 15 further comprising a central ignition aid connected to the first and second overvoltage protection elements.

18. The overvoltage protection system as recited in claim 15 wherein the first and second overvoltage protection elements are disposed in a common housing.

19. The overvoltage protection system as recited in claim 15 wherein:
the first overvoltage protection element includes a first and a second electrode with a first air breakdown spark gap therebetween; and
the second overvoltage protection element includes a third and a fourth electrode with a second air breakdown spark gap therebetween;
wherein the first, second, third and fourth electrodes are disposed so that the second air breakdown spark gap ignites when the first air breakdown spark gap ignites and the first air breakdown spark gap ignites when the second air breakdown spark gap ignites due to a presence of a plasma.

20. The overvoltage protection system as recited in claim 16 wherein:
the first ignition aid includes a first ignition electrode and a first ignition circuit connected to the first ignition electrode; and
the second ignition aid includes a second ignition electrode and a second ignition circuit connected to the second ignition electrode.

21. The overvoltage protection system as recited in claim 17 wherein the central ignition aid includes a first and a second ignition electrode and a central ignition circuit connected to the first and second ignition electrodes, the first ignition electrode cooperating with the first overvoltage protection element and the second ignition electrode cooperating with the second overvoltage protection element.

22. The overvoltage protection system as recited in claim 19 wherein the first and second electrodes are disposed coaxially with respect to each other and the third and fourth electrodes are disposed coaxially with respect to each other.

23. The overvoltage protection system as recited in claim 22 further comprising a first ignition electrode disposed coaxially with respect to the first and second electrodes and a second ignition electrode disposed coaxially with respect to the third and fourth electrodes.

24. The overvoltage protection system as recited in claim 22 wherein the first, second, third and fourth electrodes each have a respective varying cross-section over a length of the respective electrode.

25. The overvoltage protection system as recited in claim 24 wherein the first and second ignition electrode each have a respective varying cross-section over a length of the respective electrode.

26. The overvoltage protection system as recited in claim 18 wherein the housing surrounds the electrodes and includes a lining.

27. The overvoltage protection system as recited in claim 26 wherein the housing includes POM-Teflon.

28. The overvoltage protection system as recited in claim 18 wherein the housing surrounds the electrodes and has a sealed, pressure-tight and pressure-resistant design.

29. The overvoltage protection system as recited in claim 28 wherein the housing has an outer pressure cylinder.

30. A method for operation of a multipole overvoltage protection system in a multiphase power supply system, the overvoltage protection system including a first and a second overvoltage protection element each connected in a respective leg of the power supply system, the method comprising coupling the first and second overvoltage protection elements so that the second overvoltage protection element ignites when the first overvoltage protection element ignites and so that the first overvoltage protection element ignites when the second overvoltage protection element ignites.

31. The method as recited in claim 30 wherein the multiphase power supply system includes a low voltage system.

32. The method as recited in claim 30 wherein:
the first overvoltage protection element includes a first ignition aid; and
the second overvoltage protection element includes a second ignition aid connected so as to ignite when the first ignition aid ignites and so that the first ignition aid ignites when the second ignition aid ignites.

33. The method as recited in claim 30 wherein:
the first overvoltage protection element includes a first air breakdown spark gap; and
the second overvoltage protection element includes a second air breakdown spark gap;
wherein the first and second air breakdown spark gaps are disposed in a common housing so that a first plasma produced upon an igniting of the first air breakdown spark gap ignites the second air breakdown spark gap and a second plasma produced upon an igniting of the second air breakdown spark gap ignites the first air breakdown spark gap.
